(19) United States
(12) Patent Application Publication
(10) Pub. No.: US 2007/0005465 A1
(43) Pub. Date: Jan. 4, 2007

(54) Joint sponsor-manager handling of custodian transactions

(75) Inventors: Amy Kandravy, Norwell, MA (US); Lorraine Giordano, Hoboken, NJ (US); Charles Smith, Hoboken, NJ (US); Simon Gershon, Merrick, NY (US); Adrian Feliciano, West Orange, NJ (US); Ann Harding, Maplewood, NJ (US); Donna Figlik, Chicago, IL (US); Michele Pierdinock, Hoboken, NJ (US); William McKinney, Westfield, NJ (US); Kalpesh Master, Princeton, NJ (US); Kshipra Sahajpal, Jersey City, NJ (US)

Correspondence Address: SUTHERLAND ASBILL & BRENNAN LLP, 999 PEACHTREE STREET, N.E., ATLANTA, GA, 30309, US

(73) Assignee: CHECKFREE CORPORATION, NORCROSS, GA (US)

(21) Appl. No.: 11/169,018

(22) Filed: Jun. 29, 2005

(51) Int. Cl. G06Q 40/00

(52) U.S. Cl. 705/35

(57) ABSTRACT

Techniques for approval of reconciliation of an investment account transaction are provided. A first record of a transaction associated with the investment account is stored in an investment account data repository accessible by a first entity and a second entity. A second record associated with the transaction is received from a third entity and is reconciled with the stored first record. Based upon the reconciliation, the repository is altered and an indication of an approval of the alteration, by at least one of the first entity and the second entity, is stored in the data repository.

### TECHNICAL FIELD

The present invention relates to investment portfolio management and more particularly to reconciling investment portfolio records.

### BACKGROUND ART

Referring to FIG. 1, an individual investor 10 has a single investment account (IA) with a sponsor 14. A sponsor 14 may be a brokerage firm, and for the purposes of this document, these terms are used interchangeably. Investment account data is maintained in a database 26A of an automated sponsor portfolio management system (SPMS) 26 utilized by the sponsor 14. The sponsor 14 also opens a custodial trading account (CTA) at a custodian firm 16 which is associated with the IA. The custodial trading account is entered into a database 28A of the custodian account management system (CAMS) 28 conventionally utilized by the custodian firm 16, and typically associated with the tax identifier, i.e., tax ID, of the investor 10. The official and formal records for the IA will be the records for the CTA, as maintained by the custodian firm 16.

Oftentimes a sponsor 14 leverages a money manager 20 to actually manage an IA such that the IA will have an investment style defined by the money manager 20. A money manager opens a separately managed trading account, which will sometimes be referred to as an MTA, corresponding to the IA. The trading account records for each MTA are entered into a database 30A of an automated money manger portfolio management system (MMPMS) 30 conventionally utilized by a money manager 20.

Some investment accounts are broken into multiple trading accounts (TAs). In such a case, the custodian firm 16 maintains a unique CTA for each TA. For simplicity's sake, it will be assumed that in the present example the IA is not divided into multiple TAs, though it certainly could be.

As the money manager 20 makes decisions on the managed trading account, associated trade orders, including orders to buy securities or sell securities in a particular company, are initiated by the money manager 20 and forwarded to the sponsor 14. Based on the issued trade orders, the sponsor 14 executes the trades in fulfillment of the orders. In this regard, the sponsor 14 will, through its trading desk, execute the buys and the sells to actually perform the ordered trades.

After fulfillment of one or more orders, the sponsor 14 forwards a file representing the executed buys and sells to the custodian 16. Based on the information represented in the forwarded file, the custodian 16 records the trades in the books and records for the custodial trading account. It should be stressed that the “authority book of record” for the IA is at the custodian 16, not at the sponsor 14, or the money manager 20.

Information, in the form of a file representing the information associated with the CTA and often referred to as authority data, flows from the custodian 16 to the sponsor 14, and then optionally from the sponsor 14 to the money manager 20. Accordingly, both the IA maintained by the sponsor 14 and the MTA maintained by the money manager 20 attempt to shadow the CTA maintained by the custodian 16. The custodian 16 sends the authority data, typically in batch files, to the sponsor 14 periodically, such as nightly, weekly, or monthly. Authority data can include, but is not limited to, one or more of trades, book values, cash positions, and/or security positions.

After the sponsor 14 receives the authority information a reconciliation process is invoked by the SPMS 26. Depending upon the reconciliation process used by the sponsor 14, the brokerage firm records of the IA in database 26A may be altered. Various reconciliation processes which may be practiced by the sponsor 14 and/or the money manager 20 will be discussed further below.

At some point, which may be a function of a time or an event, the sponsor 14 sends some, but not necessarily all, of its data, which may reflect reconciliation against received custodian data, to the money manager 20. This might be done upon completion of sponsor reconciliation, or upon a predetermined schedule. The MMPMS 30 then invokes another reconciliation. As with the sponsor 14, depending upon the reconciliation process practiced by the money manager 20, the money manager records of the MTA in database 30A may be altered.

Introduced above, conventionally the sponsor 14 and the money manager 20 have various processing options for reconciling authority data received from an upstream source, i.e., from the custodian 16 in the case of the sponsor 14, or from the sponsor 14 in the case of the custodian 16. These processing options include: “post-only”; “reconcile-only”; “reconcile-and-adjust”; “reconcile-and-post”; “ignore”; and “pend”. For the post-only option, all received unique authority data is accepted and entered into the receiving entity's database, i.e., database 26A or 30A. For entities that practice “post-only” reconciliation, the receiving entity accepts the received data without question (it may perform a duplicate entry check to ensure that the same entry is not posted twice, i.e., that the data is unique). This type of reconciliation is appropriate for those transactions that do not originate at the receiving entity, yet must be reflected in the receiving entity's database. Examples include an interest posting which is not calculated and entered by the receiving entity, and trade reporting for certain instruments when the trades originate outside of the receiving entity.

In the “reconcile-only” option, all received authority data for which a prior entry has been made in the receiving database, i.e., database 26A or 30A, is processed. The authority data from the upstream source is compared to the prior entry, and any differences that exceed a tolerance level are reported to a human operator for examination and resolution. Such a discrepancy is known as an exception. No changes are automatically made to the receiving entity's database for any reported exceptions. Typically, the receiving entity typically may, as desired, adjust tolerance levels. It is even possible for a receiving entity to adjust a tolerance level to zero, in which case any deviations from the prior entry would be reported as an exception, or set to infinity, in which case any deviation would be ignored. This type of reconciliation is appropriate for transactions that originated with the receiving entity and have a high likelihood of being accurate. One example is a trade transaction generated by the receiving entity.

In the “reconcile-and-adjust” option, similar to the “reconcile-only” option, all received authority data for which a prior entry has been made in the receiving database is processed. Received authority data is compared to the corresponding prior entry. If a difference within a tolerance level is detected, an adjustment is automatically made to the prior entry to bring it in line with the received entry. It should be noted that a record remains of the original, prior entry. If the difference exceeds the tolerance level, it is merely reported in a reconciliation report. As with the reconcile-only option, typically tolerance levels may, as desired, be adjusted or ignored. If ignored, all differences will result in an automatic adjustment of the prior entry. This type of reconciliation is appropriate for certain types of trade and corporate action transactions, as well as pending withdrawals and deposits.

Similar to the “reconcile-and-adjust” option, in the “reconcile-and-post” option, all received authority data for which a prior entry has been made in the receiving database is processed. The received authority data is compared to the corresponding prior entry. If a difference within a tolerance level is detected, the prior entry is replaced with the received data. Thus, no record remains of the original, prior entry. If the difference exceeds the tolerance level, it is reported in a reconciliation report. The tolerance level may be, as desired, ignored or adjusted. If ignored, any difference simply causes the received entry to replace the original, prior entry. This type of reconciliation is appropriate for transactions, which may or may not have been initiated by the receiving entity, for which the transmitting entity is considered acceptably authoritative. Examples of transactions types include dividends, fees, and commissions.

In the ignore option, received authority data is neither reconciled against, nor entered into, the receiving entity's database, or in any way causes that database to be modified. This option is typically set for certain types of transactions that are irrelevant to the receiving entity's system.

In the pend option, received authority data is entered into the database of the receiving entity in a limbo status. That is, this authority data is not yet finally posted and does not affect any other stored data. Typically, there is a subsequent human review of such pending transactions before a final posting is made. Upon review, a pending transaction might be finally posted as received, or may result in an adjustment to a prior entry.

The existing data flows, plurality of reconciliation options, and differences between the sponsor and money manager result in significant problems, including data being out of sync between the sponsor 14 and the money manager 20. Data sync problems arise in situations in which the sponsor 14 and the money manager 20 do not work off of the same authority data, i.e., the sponsor 14 massages the authority data in some manner before sending it to the money manager 20. Also, the money manager 20 may receive authority data that is not fully “clean”. That is, the money manager 20 may receive entries that later have to corrected at the sponsor 14, but the corrected entries are not forwarded to the money manager 20.

Another problem with existing reconciliation options is that manual exception management between the sponsor 14 and the money manager 20 is time-consuming and tedious. Introduced above, each entity has its own database for storing account information. To fully research an exception, the money manager 20 must either access the sponsor 14 database 26A, or request the sponsor 14 to do so, or vice versa if the exception occurs during sponsor 14 reconciliation. Also, the sponsor 14 and the money manager 20 may use different transaction codes and/or use different reconciliation options, adding to the difficultly of exception management. That is, it may be difficult for the two entities to identify records for the same transaction.

Accordingly, a need exists for a reconciliation process that overcomes the deficiencies of the prior art.

### OBJECTIVES OF THE INVENTION

It is an objective of the invention to provide an investment portfolio management system reconciliation technique that overcomes the deficiencies in existing reconciliation techniques.

Additional objects, advantages, novel features of the present invention will become apparent to those skilled in the art from this disclosure, including the following detailed description, as well as by practice of the invention. While the invention is described below with reference to preferred embodiment(s), it should be understood that the invention is not limited thereto. Those of ordinary skill in the art having access to the teachings herein will recognize additional implementations, modifications, and embodiments, as well as other fields of use, which are within the scope of the invention as disclosed and claimed herein and with respect to which the invention could be of significant utility.

### SUMMARY DISCLOSURE OF THE INVENTION

In accordance with the present invention, a method and a system for approval of reconciliation of an investment account transaction are provided. An investment account is associated with one or m ore investors, which can be an individual or an organization, and contains assets which can include, but are not limited to, cash and securities. An investment account transaction changes a position of one or more assets held in the investment account. A transaction could be a purchase, a sale, a transfer, or any other type activity which changes a position of one or more assets. Transaction reconciliation is the process of making two or more records of the same transaction consistent.

The system includes at least a data repository and a processor. The data repository is configured to store investment account information and be accessible by at least a first and second entity. The data repository could be any type of storage medium capable of storing data, including, but not limited to, a hard disk, a floppy disk, optical storage, tape storage, or any other type medium which is capable of storing data. The processor is configured to implement the method as described herein and could be any type of processor capable of functioning to implement the method, including, but not limited to, a processor as found in a typical personal computer, main-frame computer, server-type computer, or any other type computing device.

A first record of a transaction associated with the investment account is stored in the data repository. This first record is accessible, in the data repository, by both a first entity and a second entity. Both the first entity and the second entity could be any entity authorized to create and/or access information associated with the investment account, including, but not limited to, a financial advisor, a broker, a brokerage firm, or a money manager. The first record could be stored in the data repository by either the first or the second entity. A second record that is associated with, i.e., reflects, the transaction is received from a third entity. Preferably, the third entity is an account custodian. However, the third entity could be any entity authorized to create and/or access information associated with the investment account. The received second record is reconciled with the stored first record. That is, the first and second records are made consistent. This reconciliation includes altering the investment account data repository. This alteration could be an alteration of the stored first record, could be a storing of the second record, perhaps itself altered, or even could be an alteration to another stored record. An indicator of an approval of the alteration is also stored. This approval is made by at least one of the first and the second entity. Thus, an alteration to the data repository that is a result of the reconciliation is approved by either the first or the second entity, and an indication of this approval is stored.

According to one aspect of the present invention, the first entity is a sponsor of an investor with which the investment account is associated, and the second entity is a money manager that directs the transacting of at least a portion of the investment account. A sponsor is oftentimes a brokerage firm, but could be another entity.

In another aspect of the present invention, the third entity is a custodian that maintains the authority book of record for the investment account.

According to still another aspect of the invention, reconciling the received second record with the stored first record includes executing one multiple types of reconciliation processes. The executed processes is one of: a post only reconciliation process, a reconcile only reconciliation process, a reconcile and post reconciliation process, a reconcile and adjust reconciliation process, an ignore reconciliation process, and a pend reconciliation process. Each of these types of reconciliation processes will be understood by one of ordinary skill in the art.

In a different aspect of the present invention, at least one of the first entity and the second entity is notified of the alteration. An approval of the alteration is then received in response to the notification, the approval being from at least one of the first and second entities. T he storage of the indicator of the approval is made subsequent to the receiving of the approval.

According to still another aspect of the invention, at least one parameter associated with at least one of the reconciling and the approval is stored in the data repository. This parameter is stored prior to the reconciling. In a further aspect, the at least one parameter is established by at least one of the first entity and the second entity. Thus, a parameter can be jointly or individually established. In an even further aspect, the parameter is jointly established.

In yet another further aspect of the invention, the at least one parameter is one of an indicator of a type of reconciling to be used, an indicator of an entity that must approve an alteration of the investment account data repository, an indicator of a threshold for automatic authorization of an alteration of the investment account data repository on behalf of an entity, and an indicator of a type of ownership of data associated with the stored first record.

According to still another aspect of the present invention, the first record is stored in the data repository by the first entity, and the altering of the investment account data repository is a first alteration. A second alteration of the investment account data repository is made based upon the reconciling. This second alteration is made prior to the first alteration. An indication of one of a rejection or an escalation of the second altering by the second entity, prior to the first alteration, is stored in the data repository. Thus, the second entity controls whether or not an alteration will be accepted.

### BRIEF DESCRIPTION OF DRAWINGS

FIG. 1 depicts historically utilized portfolio management system architecture.

FIG. 2 depicts a portfolio management system architecture in accordance with the present invention.

FIG. 3 depicts the movement and storage of portfolio data in accordance with the present invention.

FIG. 4 is a flow chart depicting processing in accordance with certain aspects of the present invention.

### PREFERRED EMBODIMENT

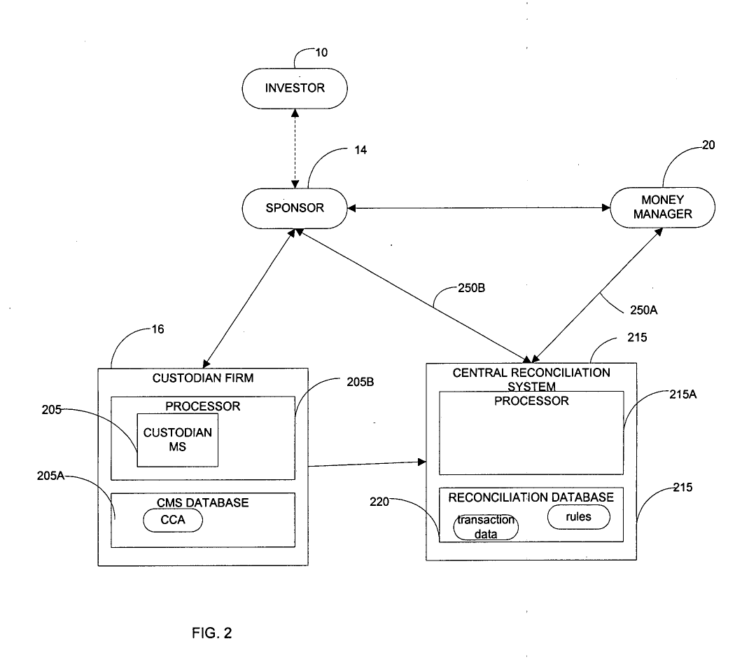

FIG. 2 depicts a portfolio management system architecture in accordance with the present invention. As shown, an individual investor 10 opens an investment account (IA) with a sponsor 14, also referred to as a brokerage firm. Similar to the discussion above, a custodian client account (CCA) is opened at the custodian firm 16. The custodian firm 16 is represented by a custodian management system (CMS) 205. The custodian client account is stored in a CMS database 205A. The CCA is maintained by the CMS 205 as the authority of record for all transactions associated with the IA. The architecture of FIG. 2 also includes at least one money manager 20. As will be appreciated, more than one money manager may participate in the present invention, in which case each would be represented by a unique MMPMS.

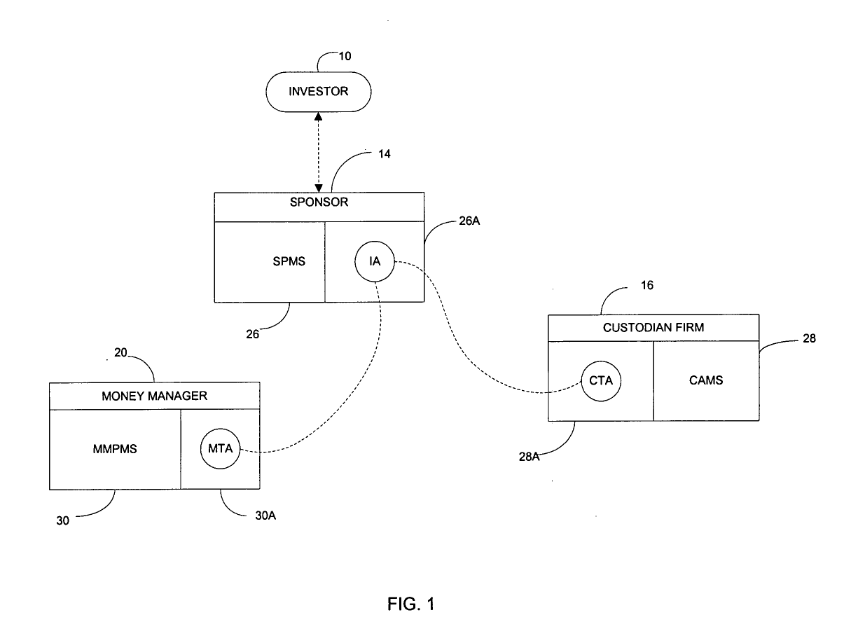

As also shown, the FIG. 2 architecture also includes a central reconciliation system (CRS) 215 serving both the sponsor 14 and the money manager 20, and which includes a reconciliation database 220 that is accessible by both the SPMS 200 and the MMPMS 210. Thus, the CRS 15 replaces at least portions of the prior art SPMS 26 and CAMS 28. The reconciliation database 220 is accessible by both the sponsor 14 and the money manager 20. The reconciliation database 220 stores data representing the IA and replaces the prior art databases associated with the sponsor 14 and money manager 20, described above. Thus, different than the architecture shown in FIG. 1 and described above, the broker firm 14 and the money manager 20 are not required to maintain individual repositories of transaction data, or even individual management systems. The CRS 215 could be located at the sponsor 14, the money manager 20, or possibly even elsewhere, such as at a service provider (not shown in the figures).

The CRS 215 is executed by processor 215A which is configured (i.e., programmed) with the logic necessary to perform various functions associated with reconciliation, to be discussed further below. It should be noted that processor 215A could, as desired, perform additional functions. The CMS 205 is executed by processor 205B and is completely distinct from the CRS 215

The reconciliation database 220 stores transaction data for the IA as well as business rules to be discussed further below. Thus, different than the conventional systems described above, the sponsor 14 and the money manager 20 are not required to maintain repositories of transaction data. Each of the sponsor 14 and money manager 20 is in communication with the CRS 215 via a communication link. The money manager 20 communicates with the CRS 215 via communication link 250A, and the sponsor 14 communicates with the CRS 215 via communication link 250B.

Because the sponsor 14 and money manager 20 share the reconciliation database 220, they must agree to the transaction types to be included in the reconciliation database 220 and the type of reconciliation process to be utilized for each included transaction type. These business rules, as well as others, are a part of the logic that drives the operation of processor 215A of the CRS 215. As desired and/or necessary, business rules can be partially, or completely, changed by the parties. As such, the stored business rules are configurable to reflect changes in the agreement between the sponsor 14 and the money manager 20. Introduced above, business rules are preferably stored in association with the reconciliation database 220. However, as desired, they could be stored elsewhere for access by the processor 215A.

It should be noted that the sponsor 14 and money manger 20 could, as desired, agree upon differing rules dependent upon the identity of a custodian from whom authority data will be received, and/or the identity of an investor with whom authority data is associated. Further, it should also be noted that the sponsor 14 will more than likely be associated with multiple money managers. In such a case, the sponsor 14 may establish, as desired, unique rules with each money manager with which the sponsor 14 is associated. Still further, business rules could vary based upon a program with which an IA is associated, the identity of a sponsor, as well as the investment style.

Other business rules, agreed to by the sponsor 14 and the money manager 20, are directed to authorization requirements. As discussed above, a particular reconciliation option, agreed to by the parties, might result in changes to data already stored in the reconciliation database 220, or even to received authorization data. Also, either the sponsor 14 or the money manager 20 might desire, for whatever reason, to manually alter stored data. In view of possible changes, the parties will agree as to whether either, or both, must approve of a change, as well as establishing primary and secondary ownership of the data. Ownership agreements can be applied the same to all data, or can be, as desired, applied on a granular level, such as by transaction type. Ownership defines the ordering of application of business rules and conflict-resolution precedence.

Yet other business rules are directed to tolerance levels. Different than the above-rules, tolerance rules are set individually by the sponsor 14 and the money manager 20. A tolerance rule dictates whether data having a value that varies from an expected value by a certain number of units will be automatically approved by the CRS 215, or held in a pending state until approved by the sponsor 14 and/or the money manager 20. Tolerance limits may be established in any of multiple unit types, including days, percentage, cost/price, etc. These rules may, as desired, vary according to transaction type.

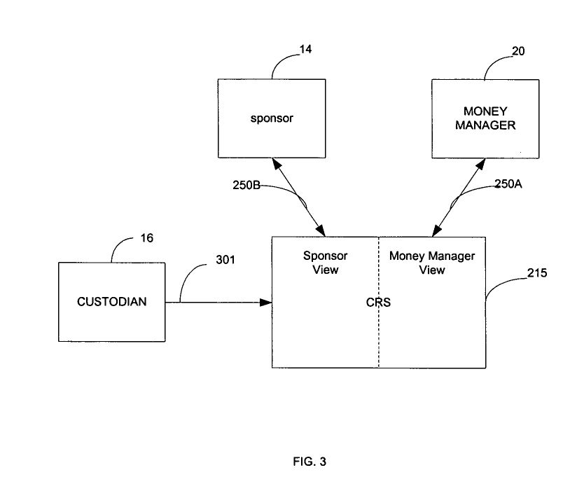

FIG. 3 is a simplified depiction of the movement, storage, and availability of authority data in accordance with the present invention. As shown, the custodian 16 transmits authority data directly to the CRS 215, via communication link 301, instead of to the sponsor 14 as in the prior art. The transmission of authority data is periodic and preferably in the form of batch files. However, as desired, authority data could be transmitted to the CRS 215 on an ad hoc basis and/or in a form other than batch files. The CRS processor 215A executes the agreed upon reconciliation process, or processes, upon receipt of the authority data. The results of reconciliation are stored in the reconciliation database 220 and are immediately available for access by the sponsor 14 via communication link 250B and the money manager 20 via communication link 250A. Thus, the sponsor 14 has a view into the reconciliation database 220, and the money manager 14 also has a view into the reconciliation database 220. It should be noted that, as desired, the brokerage firm view and the money manager view may be different, in that one party may be able to view certain data that the other party cannot.

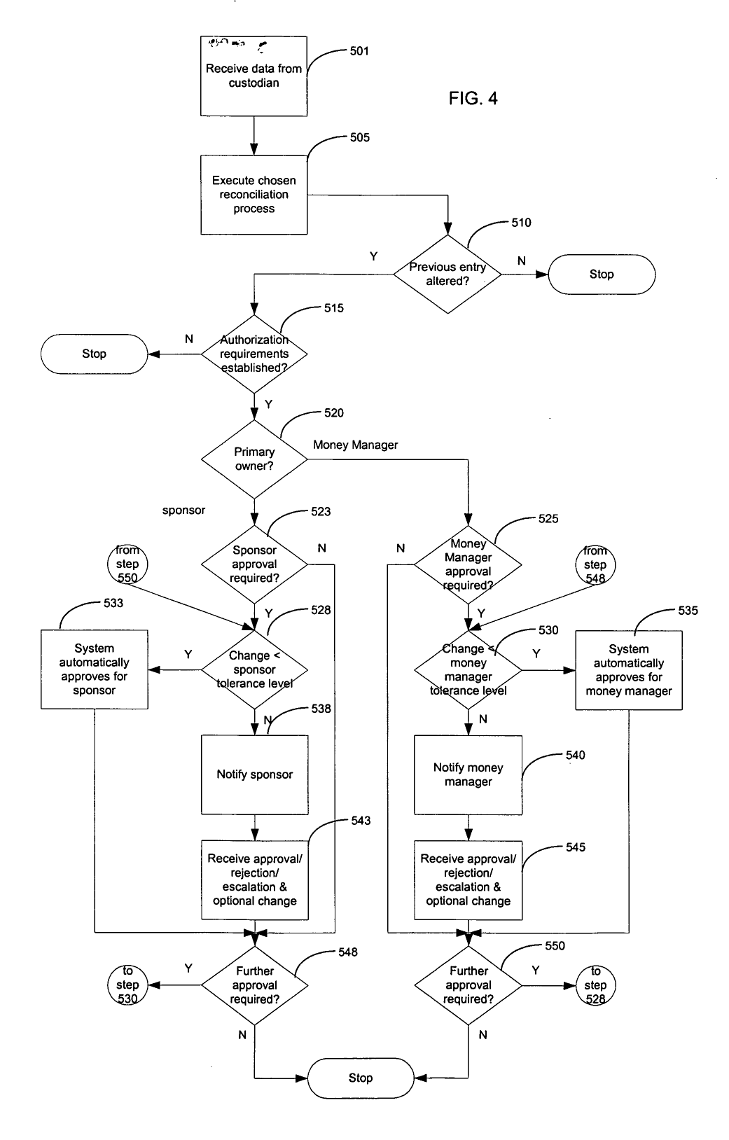

FIG. 4 is a logic diagram depicting the approval portion of the reconciliation process of the present invention when a previous entry to the reconciliation database 220 is to be altered based upon an executed reconciliation process. At step 501 the CRS 215 receives authority data from the CMS 205. Upon receipt of the authority data the CRS processor 215A executes the agreed upon reconciliation process upon at least a portion of the received authority, step 505. At step 510 the processor 215A determines if authority data previously stored in the reconciliation database 220 has been altered by the executed reconciliation process. If not, operations stop. If so, operations continue with step 515 in which the processor 215A determines if any authorization requirements have been established by either the money manager 20 or the sponsor 14. That is, the processor 215A determines if any authorization requirement rules are stored. If the determination of step 515 is negative, operations stop.

If it is determined in step 515 that authorization rules have been established, operations continue with step 520 in which the processor 215A determines the primary owner of the reconciled authority data. If the primary owner is determined to be the money manager 20, operations continue with step 525, and if the primary owner is determined to be the sponsor 14, operations continue with step 523. That is, the precedence of established rules is determined based upon the entity having primary ownership of the authority data.

If at step 520 it is determined that the sponsor 14 has primary ownership of the authority data, operations continue with step 523 in which processor 215A determines if authorization requirements have been established by the sponsor 14 for the instant type authority data. If not, operations continue with step 548, to be discussed further below. If so, at step 528, the processor 215A retrieves the sponsor 14 established tolerance rule for the instant type authority data and determines if the alteration, which might be an alteration due to an escalation, to be discussed further below, to the stored authority data is less than the established tolerance level. If so, operations continue with step 533 in which the processor 215A automatically approves the alteration for the sponsor 14. Operations then continue with step 548, to be discussed below.

If at step 528 it is determined that the alteration exceeds the established tolerance level, operations continue with step 538 in which the sponsor 14 is notified of the alteration. At step 543, following step 538, the processor 215A receives from the sponsor 14 either an approval of the alteration, a rejection of the alteration, or an escalation and optional change of the alteration.

In an escalation and optional change, an entity whose approval is being sought for an alteration may, as necessary and/or desired, counter with an alteration proposal resulting from that entity's own research. Following step 543 operations continue with step 548 in which the processor 215A determines if further approval of an alteration (which could result from an escalation) is necessary, i.e., whether the money manager 20 must approve. If not, operations stop. If it is determined that the money manager 20 must approve, operations continue with step 530.

Similar to step 528, at step 530the processor 215A determines if the alteration is less than a money manager 20 established tolerance level. If so, the processor 215A automatically approves the alteration at step 535. Thereafter, operations continue with step 550, to be discussed further below.

If at step 530 the processor 215A determines that the alteration is not less than the money manager 20 established tolerance level, operations continue with step 540, similar to step 538, in which the money manager 20 is notified of the alteration. At step 545, similar to step 543, a money manager 20 response is received by the processor 215A. The response could be an approval, a rejection, or an escalation and optional change to the alteration. At step 550 the processor 215A determines if further approval is required, i.e., by the sponsor 14. If so, operations continue with step 528. If not, operations end.

If in step 520 it is determined that the primary owner of the authority data is the money manager 20, operations continue with step 525. At step 525 the processor 215A determines if authorization requirements have been established by the money manger 20 for the instant type authority data. If not, operations continue with step 550, discussed above. However, if the money manager 20 has established authorization requirements, operations continue with step 530, also discussed above. The remaining processing, i.e., steps 530 through 550, will be understood from the discussion above.

As an example of the technique provided by the present invention, the reconciliation of a ‘buy equity’ transaction will be discussed. In this example, the sponsor 14 and the money manager 20 agree that the reconciliation process will be reconcile-and-post, that any changes resulting from a reconciliation of a ‘buy equity’ transaction will require the authorization of both parties, and the sponsor 14 has primary ownership, while the money manager 20 has secondary ownership. Also, the sponsor 14 establishes a threshold level of $1.00 for ‘buy equity’ transactions, while the money manager 20 establishes a threshold of $0.01.

The sponsor 14 orders a purchase of 100 shares of IBM stock at $90.00/share. the sponsor 14 transmits this information to the CRS 215 where processor 215A causes this information to be stored in the reconciliation database 220. When executed, 99 shares of IBM at $89.00/share are actually purchased. The CMS 205 transmits authority data reflecting the actual trade to the CRS 215.

At some point after receipt of the authority data, the processor 215A executes the reconcile-and-post process (as the chosen preference). As a result of this processing, the prior “buy 100 shares of IBM at $90.00/share” is replaced with “buy 99 shares of IBM at $89.00/share”. The processor 215A determines, based upon the stored business rules, that both the sponsor 14 and the money manger 20 must approve a change to the prior entry. As the primary owner, the sponsor 14 must approve first.

The processor 215A then accesses the stored tolerance level of the sponsor 14 to determine if an automatic system approval of the alteration can be made. Because the change exceeds the stored threshold, the processor 215A notifies the sponsor 14 of the change. Introduced above, an approving entity can either accept a change, reject a change, or escalate a change. If a change is rejected or escalated, the reviewing entity may counter with a proposal resulting from that entity's own research. In the instant example, the sponsor 14 rejects the reconciliation change and proposes, based upon its own research, an entry for “buy 101 shares of IBM at $101.00/share.”

Because the authorization requirements indicate that the money manager 20, as the secondary owner, must also approve any reconciliation-associated change, the processor 215 examines the brokerage firm's change against the money manager's stored tolerance level for automatic system approval. Because the proposed change exceeds the money manager's threshold, the processor 215A notifies the money manager 20 of the proposed change. As above, the money manager 20 could approve, reject, or escalate the change. However, as the secondary owner, dependent upon agreement between the sponsor 14 and the money manager 20, the money manager may have no, or limited, ability to suggest a counter proposal.

It should be noted that the money manager 20 and sponsor 14 may, as desired, engage in out-of-band interaction to come to agreement on the change proposed by the sponsor 14. However, as long as both parties have not approved of a change which requires approval of both, that associated transaction will appear on exception reports generated by the CRS processor 215A, even though the initial reconciliation process has been completed.

In this example, the money manager 20 and sponsor 14 do engaged in out-of-band interaction on this issue. After out-of-band interaction is completed, the money manger 20 accepts the change proposed by the sponsor 14, and the authorization requirements are thusly fulfilled. Thereafter, the change will no longer show up on exception reports, although preferably the processor 215A will retain a history of the exception and how it was handled by the CRS 215.

The present invention is not to be limited in scope by the specific embodiments described herein. Indeed, various modifications of the present invention in addition to those described herein will be apparent to those of skill in the art from the foregoing description and accompanying drawings. Thus, such modifications are intended to fall within the scope of the appended claims.

I/we claim:

1. A method for approval of reconciliation of an investment account transaction, comprising:
storing, in an investment account data repository accessible by a first entity and a second entity, a first record of a transaction associated with the investment account;
receiving, from a third entity, a second record associated with the transaction;
reconciling the received second record with the stored first record;
altering the investment account data repository based upon the reconciling; and
storing an indicator of an approval of the alteration by at least one of the first entity and the second entity.

2. The method of claim 1, wherein:
the first entity is a sponsor of an investor with which the investment account is associated; and
the second entity is a money manager that directs the transacting of at least a portion of the investment account.

3. The method of claim 1, wherein the third entity is a custodian that maintains the authority book of record for the investment account.

4. The method of claim 1, wherein reconciling the received second record with the stored first record includes executing one of (i) a post only reconciliation process, (ii) a reconcile only reconciliation process, (iii) a reconcile and post reconciliation process, (iv) a reconcile and adjust reconciliation process, (v) an ignore reconciliation process, and (vi) a pend reconciliation process.

5. The method of claim 1, further comprising:
notifying at least one of the first entity and the second entity of the alteration; and
receiving, responsive to the notification, an approval of the alteration from the at least one of the first entity and the second entity;
wherein the storage of the indicator is made subsequent to receiving the approval.

6. The method of claim 1, further comprising:
storing in the investment account data repository at least one parameter associated with at least one of (i) the reconciling, and (ii) the approval;
wherein the at least one parameter is stored prior to the reconciling.

7. The method of claim 6, wherein the at least one parameter is established by at least one of the first entity and the second entity.

8. The method of claim 7, wherein the at least one parameter is jointly established by the first entity and the second entity.

9. The method of claim 6, wherein the at least one parameter is one of (i) an indicator of a type of reconciling to be used, (ii) an indicator of an entity that must approve an alteration of the investment account data repository, (iii) an indicator of a threshold for automatic authorization of an alteration of the investment account data repository on behalf of an entity, and (iv) an indicator of a type of ownership of data associated with the stored first record.

10. The method of claim 1, wherein the first record is stored in the investment account data repository by the first entity, the altering of the investment account data repository is a first alteration, and further comprising:
a second altering of the investment account data repository based upon the reconciling prior to the first alteration; and
storing an indication of one of a rejection or an escalation of the second altering by the second entity prior to the first alteration.

11. A system for approval of reconciliation of an investment account transaction, comprising:
an investment account data repository storing a first record of a transaction associated with the investment account and accessible by a first entity and a second entity; and
a processor configured to receive, from a third entity, a second record associated with the transaction, to reconcile the received second record with the stored first record, to alter the investment account data repository based upon the reconciling, and to store an indicator of an approval of the alteration by at least one of the first entity and the second entity in the investment account data repository.

12. The system of claim 11, wherein:
the first entity is a sponsor of an investor with which the investment account is associated; and
the second entity is a money manager that directs the transacting of at least a portion of the investment account.

13. The system of claim 11, wherein the third entity is a custodian that maintains the authority book of record for the investment account.

14. The system of claim 11, wherein reconciling the received second record with the stored first record includes executing one of (i) a post only reconciliation process, (ii) a reconcile only reconciliation process, (iii) a reconcile and post reconciliation process, (iv) a reconcile and adjust reconciliation process, (v) an ignore reconciliation process, and (vi) a pend reconciliation process.

15. The system of claim 11, wherein:
the processor is further configured to notify at least one of the first entity and the second entity of the alteration, and to receive, responsive to the notification, an approval of the alteration from at least one of the first entity and the second entity; and
the storage of the indicator is made subsequent to receiving the approval.

16. The system of claim 11, wherein:
the processor is further configured to store at least one parameter associated with at least one of (i) the reconciling and (ii) the approval in the investment account data repository.

17. The system of claim 16, wherein the at least one parameter is established by at least one of the first entity and the second entity.

18. The system of claim 17, wherein the at least one parameter is jointly established by the first entity and the second entity.

19. The system of claim 16, wherein the at least one parameter is one of (i) an indicator of a type of reconciling to be used, (ii) an indicator of an entity that must approve an alteration of the investment account data repository, (iii) an indicator of a threshold for automatic authorization of an alteration of the investment account data repository on behalf of an entity, and (iv) an indicator of a type of ownership of data associated with the stored first record.

20. The system of claim 11, wherein:
the first record is stored in the investment account data repository by the first entity;
the altering of the investment account data repository is a first alteration; and
the processor is further configured to, prior to the first alteration, second alter the investment account data repository based upon the reconciling prior to the first alteration, and to store, in the investment account data repository, an indication of one of a rejection or an escalation of the second altering by the second entity prior to the first alteration.
